(19) United States
(12) Patent Application Publication
(10) Pub. No.: US 2026/0148902 A1
(43) Pub. Date: May 28, 2026

(54) MULTILAYER ELECTRONIC COMPONENT

(71) Applicant: SAMSUNG ELECTRO-MECHANICS CO., LTD., Suwon-si (KR)

(72) Inventors: Han Sol YUN, Suwon-si (KR); Hye Won KIM, Suwon-si (KR); Seo Ho LEE, Suwon-si (KR); Berm Ha CHA, Suwon-si (KR); Ji Won KIM, Suwon-si (KR)

(73) Assignee: SAMSUNG ELECTRO-MECHANICS CO., LTD., Suwon-si (KR)

(21) Appl. No.: 19/302,821

(22) Filed: Aug. 18, 2025

(30) Foreign Application Priority Data
Nov. 25, 2024 (KR) 10-2024-0169894

(51) Int. Cl. H01G 4/30; H01G 4/008; H01G 4/12

(52) U.S. Cl. CPC H01G 4/30; H01G 4/0085; H01G 4/1209

(57) ABSTRACT

A multilayer electronic component includes a body including a dielectric layer including (Ca, Sr)(Zr, Ti)O₃ as a main component, and an internal electrode alternately disposed with the dielectric layer; and an external electrode disposed on the body, wherein the dielectric layer includes a first secondary phase including a rare earth element (RE), zirconium (Zr), and oxygen (O) in an area percentage of 0.1% to 10% relative to a cross-sectional area of the dielectric layer, and the internal electrode includes a second secondary phase including nickel (Ni) and oxygen (O) in an area percentage of 0.5% to 10% relative to a cross-sectional area of the internal electrode.

### CROSS-REFERENCE TO RELATED APPLICATION(S)

This application claims benefit of priority to Korean Patent Application No. 10-2024-0169894 filed on Nov. 25, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, may be a chip condenser mounted on the printed circuit boards of various types of electronic products such as image display devices including a liquid crystal display (LCD), a plasma display panel (PDP), or the like, a computer, a smartphone, a mobile phone, or the like, serving to charge or discharge electricity therein or therefrom.

Such a multilayer ceramic capacitor may be used as a component of various electronic devices, as the multilayer ceramic capacitor has a small size with high capacitance and may be easily mounted. As various electronic devices such as computers, mobile devices, or the like have been miniaturized and implemented with high-output, demand for miniaturization and high capacitance of multilayer ceramic capacitors has increased.

Such a multilayer ceramic capacitor may be classified as Class I, which may be a product group used in a circuit requiring high reliability or stability as a capacitor having a high degree of stability and low loss, and Class II, which may be a product group used for purposes such as bypass, coupling, or the like as a capacitor having high efficiency in a small volume.

Recently, in order to minimize power consumption and heat generation under a high-voltage environment of Class I, the demand for products satisfying high capacitance characteristics or C0G characteristics having high quality factor (Q) values while minimizing equivalent series resistance (ESR) is increasing.

### SUMMARY

One of the problems to be solved by the present disclosure is to provide a multilayer electronic component capable of suppressing heat generation under a high-voltage environment.

One of the problems to be solved by the present disclosure is to provide a multilayer electronic component having low equivalent series resistance (ESR).

One of the problems to be solved by the present disclosure is to provide a multilayer electronic component having improved capacitance characteristics and a high Q value.

One of the problems to be solved by the present disclosure is to provide a multilayer electronic component satisfying COG characteristics.

The various problems to be solved by the present disclosure are not limited to the above-described contents, and can be more easily understood in the process of explaining specific embodiments of the present disclosure.

According to an aspect of the present disclosure, a multilayer electronic component includes a body including a dielectric layer including (Ca, Sr)(Zr, Ti)O₃ as a main component, and an internal electrode alternately disposed with the dielectric layer; and an external electrode disposed on the body, wherein the dielectric layer includes a first secondary phase including a rare earth element (RE), zirconium (Zr), and oxygen (O) in an area percentage of 0.1% to 10% relative to a cross-sectional area of the dielectric layer, and the internal electrode includes a second secondary phase including nickel (Ni) and oxygen (O) in an area percentage of 0.5% to 10% relative to a cross-sectional area of the internal electrode.

According to another aspect of the present disclosure, a multilayer electronic component includes a body including a dielectric layer including a dielectric material having a perovskite structure (ABO₃) as a main component, and an internal electrode alternately disposed with the dielectric layer; and an external electrode disposed on the body, wherein the dielectric layer includes a first secondary phase including a rare earth element (RE) and the B-site element in an area percentage of 0.1% to 10% relative to a cross-sectional area of the dielectric layer, and the internal electrode includes a second secondary phase including a main component metal of the internal electrode in an area percentage of 0.5% to 10% relative to a cross-sectional area of the internal electrode.

### BRIEF DESCRIPTION OF DRAWINGS

The and other aspects, features, and advantages of the present disclosure will be more clearly understood from the following detailed description, taken in conjunction with the accompanying drawings.

FIG. 1 schematically illustrates a perspective view of a multilayer electronic component according to an embodiment of the present disclosure.

FIG. 2 schematically illustrates an exploded perspective view illustrating a stack structure of internal electrodes.

FIG. 3 schematically illustrates a cross-sectional view of FIG. 1, taken along line I-I′.

FIG. 4 schematically illustrates a cross-sectional view of FIG. 1, taken along line II-II′.

FIG. 5 schematically illustrates a cross-sectional view of FIG. 1, taken along line II-II′, according to another embodiment of the present disclosure.

FIG. 6 schematically illustrates an enlarged view of a P region of FIG. 3.

FIG. 7 is an image of a cross-section of a capacitance forming portion of an embodiment of the present disclosure taken with a scanning electron microscope (SEM).

FIG. 8 is a graph of aging characteristics according to heat generation of a test example.

### DETAILED DESCRIPTION

Hereinafter, embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes, sizes, and the like, of the elements in the drawings may be exaggerated for clarity of description, and the elements denoted by the same reference numerals in the drawings may be the same elements.

In addition, in order to clearly explain the present disclosure in the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawing, a first direction may be defined as a stack direction or a thickness T direction, a second direction may be defined as a length L direction, and a third direction may be defined as a width W direction.

### Multilayer Electronic Component

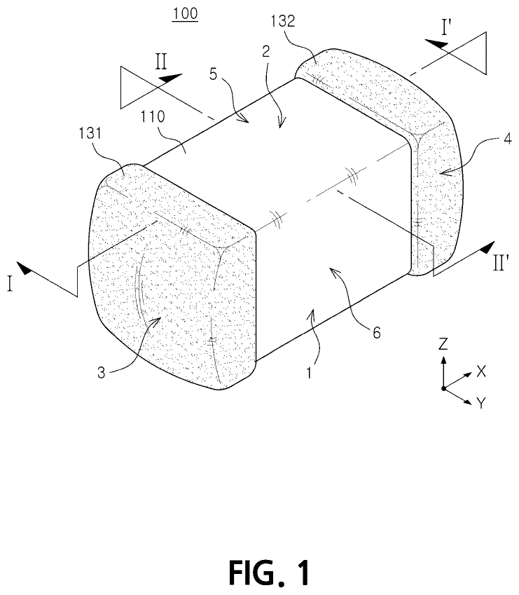

FIG. 1 schematically illustrates a perspective view of a multilayer electronic component according to an embodiment of the present disclosure.

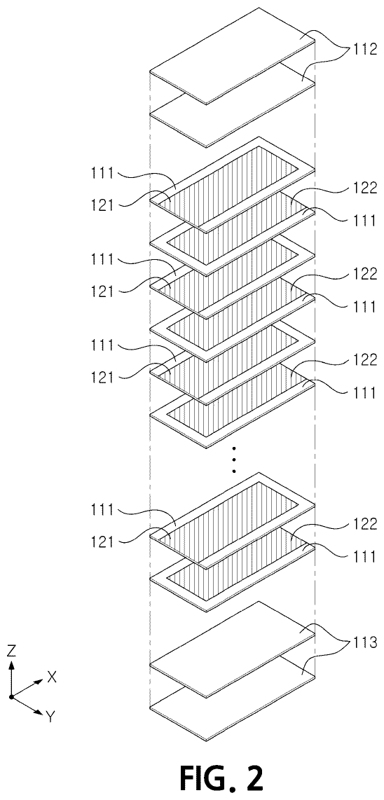

FIG. 2 schematically illustrates an exploded perspective view illustrating a stack structure of internal electrodes.

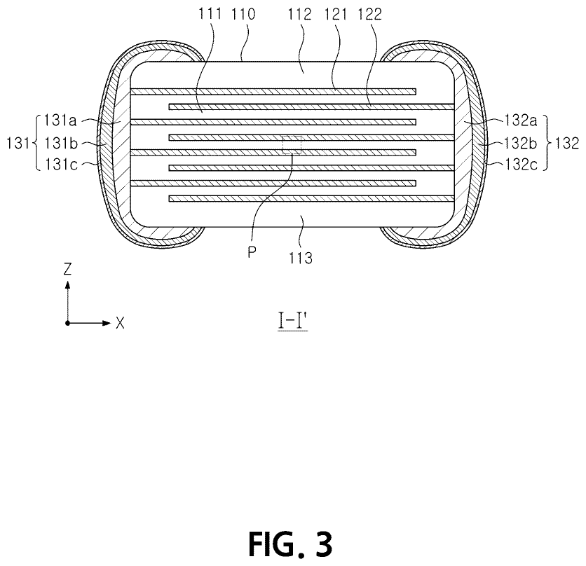

FIG. 3 schematically illustrates a cross-sectional view of FIG. 1, taken along line I-I′.

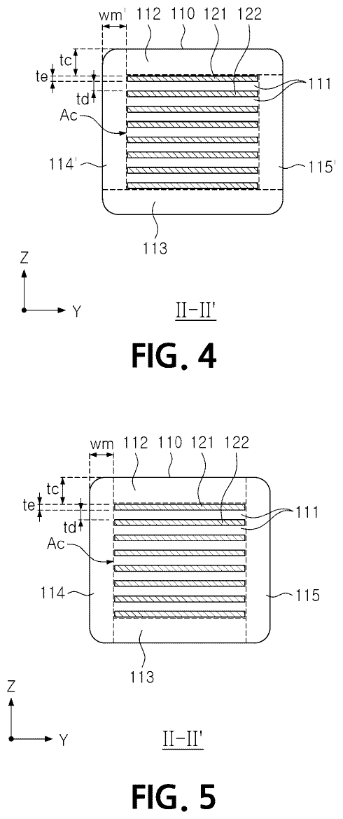

FIG. 4 schematically illustrates a cross-sectional view of FIG. 1, taken along line II-II′.

FIG. 5 schematically illustrates a cross-sectional view of FIG. 1, taken along line II-II′, according to another embodiment of the present disclosure.

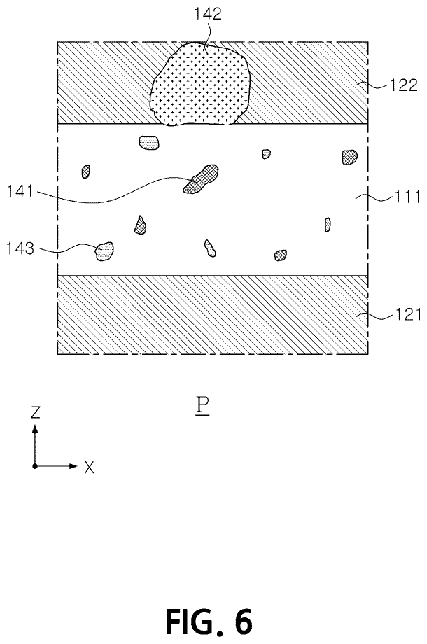

FIG. 6 schematically illustrates an enlarged view of a P region of FIG. 3.

Hereinafter, with reference to FIGS. 1 to 6, a multilayer electronic component according to some embodiments of the present disclosure will be described in detail. A multilayer ceramic capacitor will be described as an example of a multilayer electronic component, but the example embodiment may also be applied to various electronic products using a dielectric composition, such as an inductor, a piezoelectric element, a varistor, a thermistor, or the like.

A multilayer electronic component 100 according to some embodiments of the present disclosure may include a body 110 including a dielectric layer 111 comprising (Ca, Sr)(Zr, Ti)O₃ as a main component, and an internal electrode (121 and 122) alternately disposed with the dielectric layer 111; and an external electrode (131 and 132) disposed on the body 110, wherein the dielectric layer 111 may include a first secondary phase 141 including a rare earth element (RE), zirconium (Zr), and oxygen (O) in an area percentage of 0.1% to 10% relative to a cross-sectional area of the dielectric layer 111, and the internal electrode (121 and 122) may include a second secondary phase 142 including nickel (Ni) and oxygen (O) in an area percentage of 0.5% to 10% relative to a cross-sectional area of the internal electrode (121 and 122).

In addition, a multilayer electronic component 100 according to another embodiments of the present disclosure may include a body 110 including a dielectric layer 111 including a dielectric material having a perovskite structure (ABO₃) as a main component, and an internal electrode (121 and 122) alternately disposed with the dielectric layer 111; and an external electrode (131 and 132) disposed on the body 110, wherein the dielectric layer 111 includes a first secondary phase 141 including a rare earth element (RE) and the B-site element in an area percentage of 0.1% to 10% relative to a cross-sectional area of the dielectric layer 111, and the internal electrode (121 and 122) includes a second secondary phase 142 including a main component metal of the internal electrode (121 and 122) in an area percentage of 0.5% to 10% relative to a cross-sectional area of the internal electrode (121 and 122).

The body 110 may have the dielectric layers 111 and the internal electrode (121 and 122), alternately stacked.

More specifically, the body 110 may include a first internal electrode 121 and a second internal electrode 122, alternately arranged to face each other, with the dielectric layer 111 therebetween, to provide a capacitance forming portion Ac forming capacitance.

Although a specific shape of the body 110 is not particularly limited, the body 110 may have a hexahedral shape or the like, as illustrated. Due to shrinkage of ceramic powder particles included in the body 110 during a sintering process, the body 110 may not have a perfectly straight hexahedral shape, but may have a substantially hexahedral shape.

The body 110 may include first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3, and 4 and opposing each other in a third direction.

A plurality of dielectric layers 111 forming the body 110 may be in a sintered state, and a boundary between adjacent dielectric layers 111 may be integrated to such an extent that it may be difficult to identify the same without using a scanning electron microscope (SEM).

Recently, as the demand for products satisfying a C0G characteristic having a quality factor (Q) value while minimizing equivalent series resistance (ESR) under a high-voltage environment, and minimizing heat generation, is increasing, it is necessary to design an optimal composition ratio.

In this case, the Q value may be expressed as Q=1/DF=(1/ESR)*(1/ωC) (where ω=2πf), and may correspond to the reciprocal of a dissipation factor (DF). The dissipation factor may be also called dielectric loss, and may also be expressed as a loss tangent (tan δ). Definition of the dissipation factor may be a time rate at which electric energy is converted into heat in a dielectric when an electric field changing over time is applied.

The C0G characteristic may refer to a C0G characteristic defined in an EIA standard, and within the temperature range of −55° C. to 125° C., a capacitance change rate (ΔC) based on a capacitance value at 25° C. (C_{825° C.}) may correspond a temperature coefficient α (10⁻⁶/K(° C.)) of 0, and an allowable error of a temperature coefficient of ±30 ppm. For example, the COG characteristic may mean satisfying ΔC/C_{825° C.}=(0±30 ppm)/° C. in a temperature range of −55° C. to 125° C.

In a raw material forming the dielectric layer 111, A-site elements among perovskite (ABO₃)-based dielectric materials as main components to satisfy the COG characteristics, may include calcium (Ca) and strontium (Sr), and B-site elements may include zirconium (Zr) and titanium (Ti). For example, the dielectric layer 111 may include (Ca, Sr)(Zr, Ti)O₃ (CSZT) dielectric materials as the main components.

In this case, in the dielectric layer 111, if a ratio of calcium (Ca) in a A-site of a perovskite (ABO₃)-based structure is defined as x, and a ratio of strontium (Sr) is defined as 1-x, and, in a B-site of the perovskite structure, a ratio of zirconium (Zr) is defined as y, and a ratio of titanium (Ti) is defined as 1-y, x may be greater than 0 and less than or equal to 0.5, or y may be greater than 0 and less than or equal to 0.5. For example, (Ca, Sr)(Zr, Ti)O₃ may satisfy a chemical formula (Ca₁₋ₓ, Srₓ) (Zr_{1-y}, Ti_{y})O₃ (0<x≤0.5, 0<y≤0.5).

The dielectric layer 111 may be formed using a perovskite (ABO₃)-based dielectric material such as (Ca, Sr)(Zr, Ti)O₃, and thus may include a dielectric microstructure after sintering. The dielectric microstructure may include a plurality of grains, grain boundaries disposed between adjacent grains, and triple points disposed at points at which three or more grain boundaries meet, and the number of grains, grain boundaries, and triple points may be plural.

In this case, the grains included in the dielectric layer 111 may have a crystal lattice structure of the (Ca, Sr)(Zr, Ti)O₃ dielectric material, and a lower limit of the average size of the grains may be 0.1 μm or more, and an upper limit thereof may be 5 μm or less, 3 μm or less, or 2 μm or less.

An average size of the grains may be obtained by measuring the average size of the grains included in the dielectric layer 111 of the capacitance forming portion Ac, based on an image taken of 30 μm×20 μm (second direction length×first direction length) of the first and second direction cross-sections of the capacitance forming portion Ac of the body 110, using a scanning electron microscope (SEM). More specifically, an average size of a grain may be obtained by measuring a major diameter and a minor diameter passing through a center of one grain and then obtaining an average value, and an average size of grains may be obtained by expanding the average size of the grain obtained in this manner to multiple. However, it is not limited thereto, and the average size of the grain or the average size of the grains may be obtained by any method or program (e.g., ‘ImageJ’) capable of obtaining the average size, or by using a size measurement program or the like built into a scanning electron microscope (SEM) or the like.

In the present disclosure, the “main component” may mean a component occupying a relatively large weight ratio or a relatively large atomic number ratio, as compared to other components, and may mean a component having a weight exceeding 50 wt %, a component having an atomic number or an atomic percentage exceeding 50 at %, or a component having a molar number exceeding 50 mol %, based on a configuration corresponding thereto.

In addition, in the present disclosure, as an example of a more specific method for measuring amounts of elements included in each configuration of the multilayer electronic component 100, in a destructive method, components may be analyzed using an EDS mode of a scanning electron microscope (SEM), an EDS mode of a transmission electron microscope (TEM), or an EDS mode of a scanning transmission electron microscope (STEM). Taking the dielectric layer 111 as an example, a thinned analysis sample may be prepared using a focused ion beam (FIB) device in a region including a dielectric microstructure such as a dielectric grain or the like in a cross-section of a dielectric layer 111 in which sintering is completed. Then, a surface damage layer of the thinned sample may be removed using xenon (Xe) or argon (Ar) ion milling, and then each component to be measured may be mapped from an image obtained using SEM-EDS, TEM-EDS, or STEM-EDS to perform a qualitative/quantitative analysis. In this case, a qualitative/quantitative analysis graph of each component may be expressed by converting it into a mass percentage (wt %), an atomic percentage (at %), or a mole percentage (mol %) of each element. In this case, the mole number of another specific component may be expressed by converting it into the mole number of a specific component.

Another method may be to crush a chip to select a region containing the dielectric microstructure, and analyze components of the region containing the dielectric microstructure using an inductively coupled plasma optical spectroscopy (ICP-OES), an inductively coupled plasma mass spectrometer (ICP-MS), or the like.

In addition, in the raw material forming the dielectric layer 111, various additives, organic solvents, binders, dispersants, or the like may be added to dielectric particles of CSZT according to the purpose of the present disclosure, and the additives may be detected as auxiliary components in the dielectric layer 111.

In the present disclosure, the “auxiliary component” may mean a component occupying a relatively small weight ratio or a relatively small atomic number ratio, as compared to other components, and may mean a component having a weight of less than 50 wt %, a component having an atomic number or an atomic percentage of less than 50 at %, or a component having a molar number of less than 50 mol %, based on a configuration corresponding thereto.

The auxiliary component may include a first auxiliary component (element) including a rare earth element (RE).

In this case, the rare earth element (RE) may include at least one selected from the group consisting of yttrium (Y), cerium (Ce), lanthanum (La), praseodymium (Pr), and neodymium (Nd), may be preferably at least one selected from the group consisting of yttrium (Y), cerium (Ce), lanthanum (La), praseodymium (Pr), and neodymium (Nd), and may be more preferably yttrium (Y).

The rare earth element (RE) may improve reliability, and may react with the main component to form the first secondary phase 141 described below.

An amount of the first auxiliary component is not particularly limited, but in at least a portion of the dielectric layer 111, the amount of the first auxiliary component may be 0.1 mol or more and 2.0 mol or less relative to 100 mol of the main component, or 0.1 mol or more and 2.0 mol or less, relative to 100 mol of the B-site among the main components of the perovskite (ABO₃) structure. In this case, the amount of the first auxiliary component may mean a molar number of a first auxiliary component element.

The dielectric layer 111 may include the first auxiliary component in an amount of 0.1 mol or more and 2.0 mol or less, relative to 100 mol of the main component, to control grain growth of grains included in the dielectric layer 111 and allow size distribution uniform, thereby improving reliability.

The dielectric layer 111 may include a first secondary phase 141 including a rare earth element (RE) and a B-site element having a perovskite structure (ABO₃). More specifically, the dielectric layer 111 may include a first secondary phase 141 including a rare earth element (RE), zirconium (Zr), and oxygen (O).

More specifically, for example, the first secondary phase 141 may include at least one selected from the group consisting of RE₂Zr₂O₇, REZrO₃, E₂ZrO₅, and RE-doped ZrO₂, but the disclosure is not limited thereto, and the first secondary phase 141 may include any one satisfying stoichiometry of the rare earth element (RE), zirconium (Zr), and oxygen (O).

The first secondary phase 141 may be a result of a reaction of the first auxiliary component including the rare earth element (RE), with the main components, zirconium (Zr) and oxygen (O).

Since the dielectric layer 111 may include the first secondary phase 141 in an appropriate area to suppress movement of charges within the dielectric layer 111, thereby preventing insulation resistance (IR) from being reduced. The first secondary phase 141 may form an interface such as a grain boundary, such that a depletion layer, which may be a space charge layer with a high concentration of ions or electrons, may be formed. As a result, a resistance value of the first secondary phase 141 may be higher than a resistance value within the grains. Therefore, since a tunneling phenomenon of charge carriers due to thermionic activation may be suppressed, an effect of increasing reliability may be expected.

In this case, the dielectric layer 111 may include the first secondary phase 141 in an area percentage of 0.1% or more and 10% or less relative to a cross-sectional area of the dielectric layer 111.

The first secondary phase 141 may be observed in the following manner, but the disclosure is not limited thereto. More specifically, for example, when EDS analysis is performed on 30 μm×20 μm (second direction length×first direction length) of the first and second direction cross-sections of the capacitance forming portion Ac of the body 110 using a scanning electron microscope (SEM), a transmission electron microscope (TEM), or a scanning transmission electron microscope (STEM), the secondary phase including a rare earth element (RE), zirconium (Zr), and oxygen (O) in the dielectric layer 111 may be interpreted as the first secondary phase 141.

In the present disclosure, “secondary phase” may mean a particle or segregation having a different composition or a different crystal lattice from the perovskite-based (ABO₃) dielectric particles.

The area percentage of the first secondary phase 141 relative to the cross-sectional area of the dielectric layer 111 may be obtained by the following method, but the disclosure is not limited thereto. More specifically, 30 μm×20 μm (second direction length×first direction length) of the capacitance forming portion Ac of the body 110 in the first and second directions may be acquired by obtaining an area of the dielectric layer 111 and an area of the first secondary phase 141 through a program or the like (e.g., ‘ImageJ’ or a ‘program built into a scanning electron microscope (SEM)’), and converting the area of the first secondary phase 141 relative to the area of the dielectric layer 111 into a percentage, based on an image taken by a scanning electron microscope (SEM) or the like (SEM, TEM, STEM).

In this case, a lower limit of an average size of the first secondary phases 141 may be 0.1 μm or more, and an upper limit thereof may be 5 μm or less, 3 μm or less, or 2 μm or less. A plurality of first secondary phases 141 may be included in the dielectric layer 111, and a lower limit of an average size of each of the plurality of first secondary phases 141 may be 0.1 μm or more, and an upper limit thereof may be 5 μm or less, 3 μm or less, or 2 μm or less. When the dielectric layer 111 includes the plurality of first secondary phases 141, an area percentage of the first secondary phase 141 relative to the cross-sectional area of the dielectric layer 111 may be a value converted into a percentage of a sum of areas of the plurality of first secondary phases 141 included in a region corresponding thereto, relative to the cross-sectional area of the dielectric layer 111 in the corresponding region.

A method for obtaining the size of the first secondary phase 141 may be performed in a manner obtaining an average size of a grain or an average size of grains, described above, but the disclosure is not limited thereto.

When the dielectric layer 111 includes the first secondary phase 141 in an area percentage of 0.1% or more and 10% or less relative to the cross-sectional area of the dielectric layer 111, high-temperature reliability and insulation resistance (IR) characteristics may be improved, and a high Q value may be implemented.

When the dielectric layer 111 includes the first secondary phase 141 in an area percentage of less than 0.1% relative to the cross-sectional area of the dielectric layer 111, there may be a concern that high-temperature reliability or insulation resistance (IR) characteristic is not sufficiently improved, and when the dielectric layer 111 includes the first secondary phase 141 in an area percentage of more than 10% relative to the cross-sectional area of the dielectric layer 111, there may be a concern that COG characteristics may not be satisfied.

The auxiliary component may include a second auxiliary component (element) including a transition metal.

In this case, the transition metal may include variable valence acceptor elements, preferably at least one selected from the group consisting of manganese (Mn), vanadium (V), chromium (Cr), iron (Fe), cobalt (Co), nickel (Ni), copper (Cu), and zinc (Zn), and more preferably at least one selected from the group consisting of manganese (Mn), iron (Fe), nickel (Ni), and zinc (Zn).

The second auxiliary component may play roles of imparting reduction resistance, improving densification of the dielectric microstructure, and maintaining a stable high-temperature accelerated lifespan, and may react with the main component or another auxiliary component (e.g., third auxiliary component) to form a third secondary phase 143 described below.

An amount of the second auxiliary component is not particularly limited, but in at least a portion of the dielectric layer 111, the amount of the second auxiliary component may be 0.1 mol or more and 2.0 mol or less relative to 100 mol of the main component, or 0.1 mol or more and 2.0 mol or less relative to 100 mol of the B-site among the main components of the perovskite (ABO₃) structure. In this case, the amount of the second auxiliary component may mean a molar number of a second auxiliary component element.

The auxiliary component may include a third auxiliary component (element) including silicon (Si). More specifically, for example, the third auxiliary component may include glass including silicon (Si). In this case, when the third auxiliary component include glass, the third auxiliary component material may have a substantially amorphous shape or a substantially crystal lattice structure, and may be defined as a secondary phase in the present disclosure.

The third auxiliary component may play a role of a sintering agent, may play roles of lowering a sintering temperature and reacting with the main component or other auxiliary components (e.g., second auxiliary component) to promote sintering, and may form a third secondary phase 143 described below.

An amount of the third auxiliary component is not particularly limited, but in at least a portion of the dielectric layer 111, the amount of the third auxiliary component may be 0.1 mol or more and 2.0 mol or less relative to 100 mol of the main component, or 0.1 mol or more and 2.0 mol or less relative to 100 mol of the B-site among the main components of the perovskite (ABO₃) structure. In this case, the amount of the third auxiliary component may mean a molar number of a third auxiliary component element.

The dielectric layer 111 may include a third secondary phase 143 including the second auxiliary component and the third auxiliary component. For example, the dielectric layer 111 may include a third secondary phase 143 including a transition metal and silicon (Si). The third secondary phase 143 may be a result of a reaction between a second auxiliary component including a transition metal and a third auxiliary component including silicon (Si), or may be a result of the second auxiliary component including a transition metal being included in a material of the third auxiliary component including silicon (Si), e.g., glass, which may be amorphous.

The third secondary phase 143 may be observed in the following manner, but the disclosure is not limited thereto. More specifically, for example, when EDS analysis is performed on 30 μm×20 μm (second direction length×first direction length) of the first and second direction cross-sections of the capacitance forming portion Ac of the body 110 using a scanning electron microscope (SEM), a transmission electron microscope (TEM), or a scanning transmission electron microscope (STEM), the secondary phase including a transition metal and silicon (Si) in the dielectric layer 111 may be interpreted as the third secondary phase 143.

In this case, the dielectric layer 111 may include the third secondary phase 143 in an area percentage of 0.1% or more and 5% or less relative to the cross-sectional area of the dielectric layer 111.

A method for obtaining the area percentage of the third secondary phase 143 relative to the cross-sectional area of the dielectric layer 111 may be the same as the method for obtaining the area percentage of the first secondary phase 141 relative to the cross-sectional area of the dielectric layer 111 described above, and thus will be omitted.

In this case, the third secondary phase 143 may have a size of 0.1 μm or more and 2 μm or less, and a plurality of third secondary phases 143 may be included in the dielectric layer 111. When the dielectric layer 111 includes the plurality of third secondary phases 143, the area percentage of the third secondary phase 143 relative to the cross-sectional area of the dielectric layer 111 may be a value converted into a percentage of a sum of areas of the plurality of third secondary phases 143 included in a region corresponding thereto, relative to the cross-sectional area of the dielectric layer 111 in the corresponding region.

A method for obtaining the size of the third secondary phase 143 may be performed in a manner obtaining an average size of a grain or an average size of grains, described above, but the disclosure is not limited thereto.

The dielectric layer 111 may include the third secondary phase 143 in an area percentage of 0.1% or more and 5% or less relative to the cross-sectional area of the dielectric layer 111, thereby improving compactness and enhancing a sintering density, and suppressing creation of pores.

When the dielectric layer 111 includes the third secondary phase 143 in an area percentage of less than 0.1% of the cross-sectional area of the dielectric layer 111, there may be a concern that low-temperature sintering is difficult and the density is not sufficiently improved. When the dielectric layer 111 includes the third secondary phase 143 in an area percentage of more than 5% of the cross-sectional area of the dielectric layer 111, there may be a concern that dielectric properties are deteriorated, and there may be a concern that excessive sintering shrinkage suppresses grain growth and generates more pores, or there may be a concern that COG properties are not achieved.

To distinguish the dielectric layer 111 in the capacitance forming portion (Ac) from dielectric layers included in a cover portion (112 and 113) and a side margin portion (114 and 115), described later, a dielectric layer included in the capacitance forming portion Ac may be defined as a first dielectric layer 111, a dielectric layer included in the cover portion (112 and 113) may be defined as a second dielectric layer, and a dielectric layer included in the side margin portion (114 and 115) may be defined as a third dielectric layer.

In this case, dielectric materials included in the second and third dielectric layers may include a dielectric material, identical to the perovskite (ABO₃)-based (e.g., CSZT) material included in the first dielectric layer 111, but are not limited thereto, and may include a barium titanate (BaTiO₃)-based dielectric material or barium zirconium oxide (BaZrO₃)-based dielectric material to improve mechanical properties and electrical properties, but are likewise not limited thereto.

The second and third dielectric layers may be formed using a dielectric material such as perovskite (ABO₃), in a similar manner to the first dielectric layer 111, and may thus include a dielectric microstructure after sintering. The dielectric microstructure may include a plurality of grains, grain boundaries disposed between adjacent grains, and triple points disposed at points at which three or more grain boundaries meet, and the number of grains, grain boundaries, and triple points may be plural, respectively.

A first direction length td of the dielectric layer 111 is not limited thereto.

To secure reliability of the multilayer electronic component 100 under a high voltage environment, the first direction length td of the dielectric layer 111 may be 10 μm or less (td≤10 μm). In addition, to achieve miniaturization and high capacitance of the multilayer electronic component 100, the first direction length td of the dielectric layer 111 may be 3 μm or less. To more easily achieve miniaturization and high capacitance, the first direction length td of the dielectric layer 111 may be 1 μm or less, preferably 0.6 μm or less, and more preferably 0.4 μm or less.

In this case, the first direction length td of the dielectric layer 111 may mean a first direction length td of a dielectric layer 111 disposed between the first and second internal electrodes 121 and 122.

The first direction length td of the dielectric layer 111 may mean a length, a distance, a size, a length, or the like of the dielectric layer 111 in the first direction, or may mean a thickness of the dielectric layer.

In this case, the first direction length td of the dielectric layer 111 may be a concept including a first direction length td of at least one of the plurality of dielectric layers 111, or may be a concept including a first direction length td of each of all the dielectric layers 111.

In addition, the first direction length td of the dielectric layer 111 may mean a first direction average length td of one dielectric layer 111, may mean a first direction average length td of each of the plurality of dielectric layers 111, or may mean a first direction average length td of the plurality of dielectric layers 111.

The first direction average length td of the dielectric layer 111 may be measured by scanning images of the first and second direction cross-sections of the body 110 with a scanning electron microscope (SEM) at 10,000× magnification. More specifically, the first direction average length td of one dielectric layer 111 may mean an average value calculated by measuring first direction lengths of one dielectric layer 111 at five (5) equally spaced points in the second direction in scanned images. The five (5) equally spaced points may be designated in the capacitance forming portion Ac. In addition, when this average value measurement is extended to three dielectric layers 111 to measure an average value, the first direction average length td of plurality of dielectric layers 111 may be further generalized.

The internal electrode (121 and 122) may be alternately stacked with the dielectric layers 111.

The internal electrode (121 and 122) may include a first internal electrode 121 and a second internal electrode 122, and the first and second internal electrodes 121 and 122 may be alternately disposed to face each other with the dielectric layer 111 forming the body 110 interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and connected to the first internal electrode 121, and a second external electrode 132 may be disposed on the fourth surface 4 of the body 110 and connected to the second internal electrode 122.

For example, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by the dielectric layer 111 disposed therebetween.

The body 110 may be formed by alternately stacking and then sintering a first ceramic green sheet on which a first internal electrode paste is printed and a second ceramic green sheet on which a second internal electrode paste is printed.

A material forming the internal electrode (121 and 122) is not particularly limited, and a material having excellent electrical conductivity may be used as the main component metal. For example, the internal electrode (121 and 122) may include one or more selected from the group consisting of nickel (Ni), copper (Cu), palladium (Pd), silver (Ag), gold (Au), platinum (Pt), tin (Sn), tungsten (W), titanium (Ti), and an alloy thereof.

In addition, the internal electrode (121 and 122) may be formed by printing a conductive paste for internal electrodes including one or more selected from the group consisting of nickel (Ni), copper (Cu), palladium (Pd), silver (Ag), gold (Au), platinum (Pt), tin (Sn), tungsten (W), titanium (Ti), and an alloy thereof on a ceramic green sheet. A printing method of the conductive paste for internal electrodes may use a screen printing method, a gravure printing method, or the like, and the present disclosure is not limited thereto.

The internal electrode (121 and 122) may include a second secondary phase 142 including a main component metal of the internal electrode (121 and 122). More specifically, the internal electrode (121 and 122) may include a second secondary phase 142 including nickel (Ni) and oxygen (O).

The second secondary phase 142 may be disposed in the internal electrode (121 and 122), or may be disposed on a portion in which the internal electrode (121 and 122) is disconnected, or may be disposed on an interface between the internal electrode (121 and 122) and an adjacent dielectric layer 111, and may be disposed such that the internal electrode (121 and 122) is in contact with at least one of one surface and the other surface facing each other in the first direction.

In this case, the main component metal of the internal electrode (121 and 122) may include one or more selected from the group consisting of nickel (Ni), copper (Cu), palladium (Pd), silver (Ag), gold (Au), platinum (Pt), tin (Sn), tungsten (W), titanium (Ti), and an alloy thereof, mentioned above.

More specifically, for example, the second secondary phase 142 may include at least one selected from the group consisting of NiO, Ni₂O₃, and Ni₃O₄, but the disclosure is not limited thereto, and the second secondary phase 142 may include any material stoichiometrically satisfying the main component metal and oxygen (O) of the internal electrode.

The internal electrode (121 and 122) may include the second secondary phase 142 in an appropriate area to control flow of current in the internal electrode (121 and 122), and suppress a thermal aging phenomenon, for example, a degradation phenomenon due to thermal aging.

The second secondary phase 142 may be observed in the following manner, but the disclosure is not limited thereto. More specifically, for example, when EDS analysis is performed on 30 μm×20 μm (second direction length×first direction length) of the first and second direction cross-sections of the capacitance forming portion Ac of the body 110 using a scanning electron microscope (SEM), a transmission electron microscope (TEM), or a scanning transmission electron microscope (STEM), the secondary phase including nickel (Ni) and oxygen (O) in the internal electrode (121 and 122) may be interpreted as the second secondary phase 142.

In this case, the internal electrode (121 and 122) may include the second secondary phase 142 in an area percentage of 0.5% or more and 10% or less relative to the cross-sectional area of the internal electrode (121 and 122).

A method for obtaining the area percentage of the second secondary phase 142 relative to the cross-sectional area of the internal electrode (121 and 122) may be the same as the method for obtaining the area percentage of the first secondary phase 141 relative to the cross-sectional area of the dielectric layer 111 described above, and thus will be omitted.

In this case, a lower limit of an average size of the second secondary phases 142 may be 0.1 μm or more, and an upper limit thereof may be 5 μm or less, 3 μm or less, or 2 μm or less. A plurality of second secondary phases 142 may be included in the internal electrode (121 and 122), and a lower limit of an average size of each of the plurality of second secondary phases 141 may be 0.1 μm or more, and an upper limit thereof may be 5 μm or less, 3 μm or less, or 2 μm or less. When the internal electrode (121 and 122) includes the plurality of second secondary phases 142, an area percentage of the second secondary phase 142 relative to the cross-sectional area of the internal electrode (121 and 122) may be a value converted into a percentage of a sum of areas of the plurality of second secondary phases 142 included in a region corresponding thereto, relative to the cross-sectional area of the internal electrode (121 and 122) in the corresponding region.

A method for obtaining the size of the second secondary phase 142 may be performed in a manner obtaining an average size of a grain or an average size of grains, described above, but the disclosure is not limited thereto.

When the internal electrode (121 and 122) includes the second secondary phase 142 in an area percentage of 0.5% or more and 10% or less relative to the cross-sectional area of the internal electrode (121 and 122), heat generation may be suppressed, and thus high-temperature life reliability may be improved.

When the internal electrode (121 and 122) includes the second secondary phase 142 in an area percentage of less than 0.5% of the cross-sectional area of the internal electrode (121 and 122), there may be a concern that high-temperature life reliability is deteriorated due to an increase in thermal aging phenomenon, and when the internal electrode (121 and 122) includes the second secondary phase 142 in an area percentage of more than 10% of the cross-sectional area of the internal electrode (121 and 122), there may be a concern that electrical characteristics are deteriorated due to excessive second secondary phase 142 interfering with flow of current of the internal electrode (121 and 122), and there may be a concern that a high Q value may not be achieved.

A first direction length te of the internal electrode (121 and 122) is not limited thereto, and the following description of the first direction length te of the internal electrode (121 and 122) may mean a first direction length te of each of the first internal electrode 121 and the second internal electrode 122.

To secure reliability of the multilayer electronic component 100 under a high voltage environment, the first direction length te of the internal electrode (121 and 122) may be 3 μm or less. In addition, to achieve miniaturization and high capacitance of the multilayer electronic component 100, the first direction length te of the internal electrode (121 and 122) may be 1 μm or less. To more easily achieve ultra-miniaturization and high capacitance, the first direction length te of the internal electrode (121 and 122) may be 0.6 μm or less, and more preferably 0.4 μm or less.

In this case, the first direction length te of the internal electrode (121 and 122) may be a concept including a first direction length te of at least one of the plurality of internal electrode (121 and 122), or may be a concept including a first direction length te of all of the internal electrode (121 and 122).

In this case, the first direction length te of the internal electrode (121 and 122) may mean a length, a distance, a size, a length, or the like of the internal electrode (121 and 122) in the first direction, or may mean a thickness of the internal electrode (121 and 122).

In this case, the first direction length te of the internal electrode (121 and 122) may be a concept including a first direction length te of at least one of the plurality of internal electrode (121 and 122), or may be a concept including a first direction length te of each of all internal electrode (121 and 122).

In addition, the first direction length te of the internal electrode (121 and 122) may mean a first direction average length te of one internal electrode (121 and 122), or may mean a first direction average length te of each of the plurality of internal electrode (121 and 122), or may mean a first direction average length te of the plurality of internal electrode (121 and 122).

The first direction average length te of the internal electrode (121 and 122) may be measured by scanning images of the first and second direction cross-sections of the body 110 with a scanning electron microscope (SEM) at 10,000× magnification. More specifically, the first average length te of one internal electrode (121 and 122) may be an average value calculated by measuring first direction lengths of one internal electrode at five (5) equally spaced points in the second direction in the scanned images. The five (5) equally spaced points may be designated in the capacitance forming portion Ac. In addition, when this average value measurement is extended to three internal electrode (121 and 122) to measure an average value, the first direction average length te of the plurality of internal electrode (121 and 122) may be further generalized.

In an embodiment of the present disclosure, a first direction length td of at least one of the plurality of dielectric layers 111 and a first direction length te of at least one of the plurality of internal electrode (121 and 122) may satisfy 2×te<td.

For example, a first direction length td of one dielectric layer 111 may be larger than twice a first direction length te of one internal electrode (121 and 122). Preferably, a first direction average length td of the plurality of dielectric layers 111 may be greater than twice a first direction average length te of the plurality of internal electrode (121 and 122).

Generally, reliability issues due to a decrease in breakdown voltage (BDV) under a high voltage environment may be a major issue for high-voltage electrical electronic components.

Therefore, to prevent a decrease in breakdown voltage under a high voltage environment, the first direction average length td of the dielectric layer 111 may be made greater than twice the first direction average length te of the internal electrode (121 and 122), thereby improving breakdown voltage characteristics.

When the first direction average length td of the dielectric layer 111 is equal to or less than twice the first direction average length te of the internal electrode (121 and 122), breakdown voltage may be decreased and a short circuit may occur between internal electrodes.

The body 110 may include a cover portion (112 and 113) disposed on first direction end-surfaces of the capacitance forming portion Ac.

Specifically, the cover portion (112 and 113) may include a first cover portion 112 disposed on one surface of the capacitance forming portion Ac in the first direction, and a second cover portion 113 disposed on the other surface of the capacitance forming portion Ac in the second direction. More specifically, for example, the cover portion (112 and 113) may include a first cover portion 112 disposed above the capacitance forming portion Ac in the first direction, and a second cover portion 113 disposed below the capacitance forming portion Ac in the first direction.

The first cover portion 112 and the second cover portion 113 may be formed by disposing or stacking a single second dielectric layer or two or more second dielectric layers on upper and lower surfaces of the capacitance forming portion Ac in the first direction, respectively, and may basically perform a role of preventing damage to the internal electrode (121 and 122) due to physical or chemical stress, and the first cover portion 112 and the second cover portion 113 may not include the internal electrode (121 and 122).

A first direction length tc of the cover portion (112 and 113) is not limited thereto, and the following description of the first direction length tc of the cover portion (112 and 113) may mean a first direction length tc of each of the first cover portion 112 and the second cover portion 113.

To more easily achieve miniaturization and high capacitance of the multilayer electronic component 100, the first direction length tc of the cover portion (112 and 113) may be 100 μm or less or 50 μm or less, preferably 30 μm or less, and more preferably 20 μm or less in ultra-small products.

In this case, the first direction length tc of the cover portion (112 and 113) may mean a first direction length of the cover portion (112 and 113).

In addition, the first direction length tc of the cover portion (112 and 113) may mean a first direction average length tc of each of the first and second cover portions 112 and 113, or may mean a first direction average length tc of the first and second cover portions 112 and 113.

The first direction average length tc of the cover portion (112 and 113) may be measured by scanning images of the first and second direction cross-sections of the body 110 with a scanning electron microscope (SEM) at 10,000× magnification. More specifically, the first direction average length tc may mean an average value calculated by measuring first direction lengths at five (5) equally spaced points in the second direction in scanned images of the cover portion (112 and 113).

In addition, the first direction average length tc of the cover portion (112 and 113) measured by the above-described method may have a value substantially the same as the first direction average length of the cover portion (112 and 113) in the first and third direction cross-sections of the body 110.

The multilayer electronic component 100 may include a side margin region (114′ and 115′) which may be a region between an end of the internal electrode (121 and 122) in the third direction and a surface of the body 110 adjacent thereto.

More specifically, the side margin region (114′ and 115′) may include a first side margin region 114′ disposed between the internal electrode (121 and 122) and the fifth surface 5, and a second side margin region 115′ disposed between the internal electrode (121 and 122) and the sixth surface 6.

As illustrated, the side margin region (114′ and 115′) may mean a region between ends of the first and second internal electrodes 121 and 122 in the third direction and a boundary surface of the body 110, based on the first and third direction cross-sections of the body 110.

The side margin region (114′ and 115′) may refer to a ceramic green sheet region excluding the internal electrode (121 and 122), when an internal electrode paste is applied onto a ceramic green sheet applied to the capacitance forming portion Ac, except for a region in which the side margin region (114′ and 115′) will be.

The side margin region (114′ and 115′) may basically play a role in preventing damage to the internal electrode (121 and 122) due to physical or chemical stress, and the first side margin region 114′ and the second side margin region 115′ may not include the internal electrode (121 and 122).

A third direction length wm′ of the side margin region (114′ and 115′) does not need to be specifically limited, and the following description of the third direction length wm′ of the side margin region (114′ and 115′) may mean a third direction length wm′ of each of the first side margin region 114′ and the second side margin region 115′.

To more easily achieve miniaturization and high capacitance of the stacked electronic component 100, the third direction length wm′ of the side margin region (114′ and 115′) may be 50 μm or less, preferably 30 μm or less, and more preferably 20 μm or less in ultra-small products.

In this case, the third direction length wm′ of the side margin region (114′ and 115′) may mean a length, a distance, a size, a length, or the like of the side margin region (114′ and 115′) in the third direction, or may mean a width of the side margin region (114′ and 115′).

In addition, the third direction length wm′ of the side margin region (114′ and 115′) may mean a third direction average length wm′ of each of the first and second side margin regions (114′ and 115′), or may mean a third direction average length wm′ of the first and second side margin regions (114′ and 115′).

The third direction average length wm′ of the side margin region (114′ and 115′) may be measured by scanning images of the first and third direction cross-sections of the body 110 with a scanning electron microscope (SEM) at 10,000× magnification. More specifically, the third direction average length wm′ may mean an average value calculated by measuring third direction lengths of one side margin region (114′ and 115′) at five (5) equally spaced points in the first direction in scanned images.

The multilayer electronic component 100 may include a side margin portion (114 and 115) disposed on third-direction end-surfaces of the body 110.

More specifically, the side margin portion (114 and 115) may include a first side margin portion 114 disposed on the fifth surface 5 of the body 110, and a second side margin portion 115 disposed on the sixth surface 6 of the body 110.

The side margin portion (114 and 115) may be formed by applying a conductive paste to a ceramic green sheet applied to the capacitance forming portion Ac, except for a portion in which the side margin portion (114 and 115) is to be formed, to form the internal electrode (121 and 122), and to suppress a step difference caused by the internal electrode (121 and 122), the internal electrode (121 and 122) after stacking may be cut to be exposed to the fifth and sixth surfaces 5 and 6 of the body 110, and disposing or stacking then a single third dielectric layer or two or more third dielectric layers on both end-surfaces of the capacitance forming portion Ac in the third direction.

The side margin portion (114 and 115) may basically play a role in preventing damage to the internal electrode (121 and 122) due to physical or chemical stress, and the first side margin portion 114 and the second side margin portion 115 may not include the internal electrode (121 and 122).

A third direction length wm of the side margin portion (114 and 115) is not limited thereto, and the following description of the third direction length wm of the side margin portion (114 and 115) may mean a third direction length wm of each of the first side margin portion 114 and the second side margin portion 115.

To more easily achieve miniaturization and high capacitance of the multilayer electronic component 100, the third direction length wm of the side margin portion (114 and 115) may be 50 μm or less, preferably 30 μm or less, and more preferably 20 μm or less in ultra-small products.

In this case, the third direction length wm of the side margin portion (114 and 115) may mean a length, a distance, a size, a length, or the like of the side margin portion (114 and 115) in the third direction, or may mean a width of the side margin portion (114 and 115).

In addition, the third direction length wm of the side margin portion (114 and 115) may mean a third direction average length wm of each of the first and second side margin portion (114 and 115), or may mean a third direction average length wm of the first and second side margin portion (114 and 115).

The third direction average length wm of the side margin portion (114 and 115) may be measured by scanning images of the first and third direction cross-sections of the body 110 with a scanning electron microscope (SEM) at 10,000× magnification. More specifically, the third direction average length wm may mean an average value calculated by measuring third direction lengths of one side margin portion (114 and 115) at five (5) equally spaced points in the first direction in scanned images.

In an embodiment of the present disclosure, a structure in which the multilayer electronic component 100 has two external electrodes (131 and 132) is illustrated, but the number, shapes, or the like of external electrodes (131 and 132) may be changed depending on a shape of the internal electrode (121 and 122) or other purposes.

The external electrode (131 and 132) may be disposed on the body 110, and may be connected to the internal electrode (121 and 122).

More specifically, the external electrode (131 and 132) may include first and second external electrodes 131 and 132 disposed on the third and fourth surfaces 3 and 4 of the body 110, respectively, and connected to the first and second internal electrodes 121 and 122, respectively. For example, the first external electrode 131 may be disposed on the third surface 3 of the body, and may be connected to the first internal electrode 121, and the second external electrode 132 may be disposed on the fourth surface 4 of the body, and may be connected to the second internal electrode 122.

In addition, the external electrode (131 and 132) may be disposed to extend on portions of the first and second surfaces 1 and 2 of the body 110, or may be disposed to extend on portions of the fifth and sixth surfaces 5 and 6 of the body 110. For example, the first external electrode 131 may be disposed on portions of the first, second, fifth, and sixth surfaces 1, 2, 5, and 6 of the body 110, and the second external electrode 132 may be disposed on portions of the first, second, fifth, and sixth surfaces 1, 2, 5, and 6 of the body 110.

The external electrode (131 and 132) may include any material as long as they have electrical conductivity, such as metal or the like, and a specific material may be determined in consideration of electrical characteristics, structural stability, or the like, and may further have a multilayer structure.

For example, the external electrode (131 and 132) may include a first electrode layer (131a and 132a) disposed on the body 110, and a second electrode layer (131b and 132b) disposed on the first electrode layer (131a and 132a). Furthermore, a third electrode layer (131c and 132c) disposed on the second electrode layer (131b and 132b) may be included.

In this case, it is preferable that the first to third electrode layers correspond to layers that may be distinguished from each other. However, it is not limited thereto, and may be distinguished according to an order of a manufacturing process, and at least some layers among the first to third electrode layers may not be distinguished from each other, and may be observed as one layer.

In the present disclosure, being “distinguished” may mean that two layers may be distinguished due to physical differences, chemical differences, and/or simple optical differences, and the disclosure is not limited thereto, but distinction between layers may be distinguished by the presence or absence of an “interface.” The interface may mean a surface on which two layers contacting each other may be distinguishable from each other, and may mean, for example, a state distinguishable through differences in components, such as EDS analysis using equipment such as a scanning electron microscope (SEM) or the like.

The first electrode layer (131a and 132a) and the second electrode layer (131b and 132b) may be formed by transferring a sheet including a conductive metal onto the body 110, or may be formed by applying and then sintering a conductive paste for an external electrode including a conductive metal to the body 110, or may be formed by dipping the body 110 into a conductive paste for an external electrode including a conductive metal, but the disclosure is not limited thereto.

The first electrode layer (131a and 132a) may include a first conductive metal and glass, and the second electrode layer (131b and 132b) may include a second conductive metal and a resin.

A material having excellent electrical conductivity may be used as the conductive metal included in the electrode layers (131a, 132a, 131b, and 132b). For example, the conductive metal may include one or more selected from the group consisting of nickel (Ni), copper (Cu), palladium (Pd), silver (Ag), gold (Au), platinum (Pt), tin (Sn), tungsten (W), titanium (Ti), and an alloy thereof, but the disclosure is not limited thereto.

In this case, the conductive metal included in the first electrode layer (131a and 132a) may be referred to as a first conductive metal, and the conductive metal included in the second electrode layer (131b and 132b) may be referred to as a second conductive metal. In this case, the first conductive metal and the second conductive metal may be the same or different from each other, and in a case in which a plurality of conductive metals are included, only some thereof may include the same conductive metal, but the disclosure is not limited thereto.

The first conductive metal included in the first electrode layer (131a and 132a) may play a role of electrically connecting with the internal electrode (121 and 122), and the glass included in the first electrode layer (131a and 132a) may play a role of improving bonding properties with the body 110.

The first conductive metal included in the first electrode layer (131a and 132a) is not particularly limited as long as it is a material that may be electrically connected with the internal electrode (121 and 122), and for example, may include at least one selected from the group consisting of nickel (Ni), copper (Cu), palladium (Pd), silver (Ag), gold (Au), platinum (Pt), tin (Sn), tungsten (W), titanium (Ti), and an alloy thereof.

The second conductive metal included in the second electrode layer (131b and 132b) may play a role of electrically connecting with the first electrode layer (131a and 132a), and the resin included in the second electrode layer (131b and 132b) may play a role of improving the bending strength.

The second conductive metal included in the second electrode layer (131b and 132b) is not particularly limited as long as it is a material that may be electrically connected with the first electrode layer (131a and 132a), and may include at least one selected from the group consisting of nickel (Ni), copper (Cu), palladium (Pd), silver (Ag), gold (Au), platinum (Pt), tin (Sn), tungsten (W), titanium (Ti), and an alloy thereof.

The second conductive metal included in the second electrode layer (131b and 132b) may include at least one of spherical particles or flake-shaped particles. For example, the second conductive metal may be composed of only the flake-shaped particles, only the spherical particles, or a mixed form of the spherical particles and the flake-shaped particles.

In this case, the spherical particles may include shapes that may not be completely spherical, for example, shapes having a length ratio of a major axis to a minor axis (major axis/minor axis) of 1.45 or less. The flake-shaped particles refer to particles having a flat and elongated shape, and is not particularly limited, but may have, for example, a length ratio of a major axis to a minor axis (major axis/minor axis) of 1.95 or more. Lengths of the major and minor axes of the spherical particle and the flake-shaped particle may be measured from images obtained by scanning cross-sections in the first and second directions cut from a central portion of the multilayer electronic component in the third direction with a scanning electron microscope (SEM).

The resin included in the second electrode layer (131b and 132b) may play a role in securing bonding properties and absorbing shock, and is not particularly limited as long as it is mixed with the second conductive metal particle to make a paste, and may include, for example, an epoxy-based resin.

In addition, the second electrode layer (131b and 132b) may include an intermetallic compound.

The intermetallic compound may be included to further improve electrical connectivity with the first electrode layer (131a and 132a). The intermetallic compound may serve to improve electrical connectivity by connecting a plurality of metal particles, and may serve to surround and connect the plurality of metal particles to each other.

In this case, the intermetallic compound may include a metal having a melting point, lower than a curing temperature of a resin. For example, since the intermetallic compound includes a metal having a melting point, lower than a curing temperature of a resin, the metal having a melting point, lower than a curing temperature of a resin, may melt during a drying process and a curing process to form some of metal particles and the intermetallic compound, to surround the metal particles. In this case, the intermetallic compound may include a low melting point metal of 300° C. or less. More specifically, for example, the intermetallic compound may include tin (Sn) having a melting point of 213 to 220° C. During the drying process and the curing process, tin (Sn) may be melted, and the melted tin (Sn) may wet the third conductive metal particles having a high melting point, such as Ag, Ni, or Cu, by capillary action, and may react with a portion of Ag, Ni, or Cu metal particles to form intermetallic compounds such as Ag₃Sn, Ni₃Sn₄, Cu₆Sn₅, Cu₃Sn, or the like. Ag, Ni, or Cu that did not participate in the reaction may remain as metal particles.

Therefore, the plurality of metal particles may include one or more of Ag, Ni, and Cu, and the intermetallic compound may include one or more of Ag₃Sn, Ni₃Sn₄, Cu₆Sn₅, and Cu₃Sn.

The third electrode layer (131c and 132c) may play a role in improving mounting characteristics, and the third electrode layer (131c and 132c) may be a plating layer formed on the second electrode layer (131b and 132b) by a plating method, but the disclosure is not limited thereto.

A type of the third electrode layer (131c and 132c) is not particularly limited, and may include, for example, at least one selected from the group consisting of nickel (Ni), tin (Sn), silver (Ag), palladium (Pd), or an alloy thereof.

The third electrode layer (131c and 132c) may be a single layer or may be a plurality of layers.

More specifically, for example, the third electrode layer may be a nickel (Ni) electrode layer or a tin (Sn) electrode layer, and may be in a configuration in which the nickel (Ni) electrode layer and the tin (Sn) electrode layer may be sequentially formed on the second electrode layer (131b and 132b), or may be in a configuration in which the tin (Sn) electrode layer, the nickel (Ni) electrode layer, and the tin (Sn) electrode layer are sequentially formed. In addition, the third electrode layer (131c and 132c) may include a plurality of nickel (Ni) electrode layers and/or a plurality of tin (Sn) electrode layers.

A size of the multilayer electronic component 100 does not need to be specifically limited.

To minimize heat generation under a high-voltage environment, since thicknesses of a dielectric layer and an internal electrode should increase, effects according to the present disclosure may be more prominent in the multilayer electronic component 100 having a size of 2012 (length×width: 2.0 mm×1.2 mm, length and width satisfy an error of ±10%) or larger or 5750 (length×width: 5.7 mm×5.0 mm, length and width satisfy an error of ±10%).

Hereinafter, the present disclosure will be described in more detail through test examples, but this may be to help a specific understanding of the invention, and the scope of the present disclosure is not limited by the test examples.

### TEST EXAMPLES

The following [Table 1] describes evaluation of heat generation (aging rate), high-temperature life reliability, and insulation resistance (IR) values, according to an area percentage of a first secondary phase included in a dielectric layer and an area percentage of a second secondary phase included in an internal electrode.

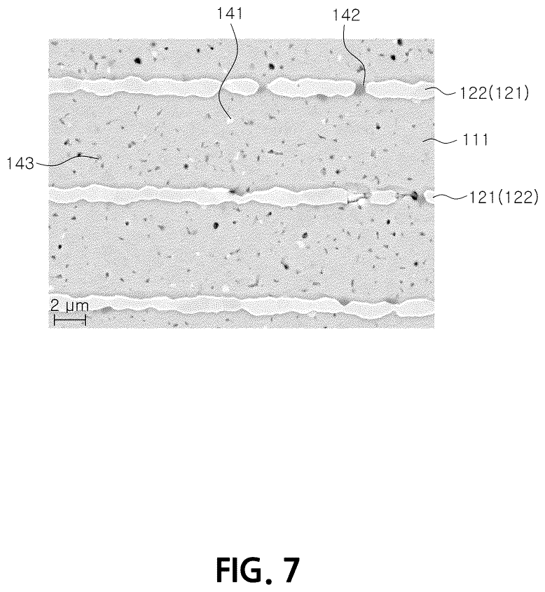

In Test Example 1, a sample chip was manufactured such that an area percentage of a first secondary phase including yttrium (Y), zirconium (Zr), and oxygen (O) relative to a cross-sectional area of a dielectric layer was 0.1% or more and 10% or less, an area percentage of a second secondary phase including nickel (Ni) and oxygen (O) relative to a cross-sectional area of an internal electrode was 0.5% or more and 10% or less, and an area percentage of a third secondary phase including manganese (Mn), iron (Fe), nickel (Ni), zinc (Zn), and silicon (Si) relative to the cross-sectional area of the dielectric layer was 0.1% or more and 5% or less. In addition, FIG. 7 is an image of a cross-section of a capacitance forming portion of Test Example 1 taken with a scanning electron microscope (SEM).

In Test Example 2, a sample chip was manufactured such that an area percentage of a first secondary phase including yttrium (Y), zirconium (Zr), and oxygen (O) relative to a cross-sectional area of a dielectric layer was 0.1% or more and 5% or less, an area percentage of a second secondary phase including nickel (Ni) and oxygen (O) relative to a cross-sectional area of an internal electrode was 0.1% or more and 5% or less, and an area percentage of a third secondary phase including manganese (Mn), iron (Fe), nickel (Ni), zinc (Zn), and silicon (Si) relative to the cross-sectional area of the dielectric layer was 0.1% or more and 5% or less.

In Test Example 3, a sample chip was manufactured such that an area percentage of a first secondary phase including yttrium (Y), zirconium (Zr), and oxygen (O) relative to a cross-sectional area of a dielectric layer was 0.1% or more and 5% or less, an area percentage of a second secondary phase including nickel (Ni) and oxygen (O) relative to a cross-sectional area of an internal electrode was more than 10%, and an area percentage of a third secondary phase including manganese (Mn), iron (Fe), nickel (Ni), zinc (Zn), and silicon (Si) relative to the cross-sectional area of the dielectric layer was 0.1% or more and 5% or less.

In Test Example 4, a sample chip was manufactured such that an area percentage of a first secondary phase including yttrium (Y), zirconium (Zr), and oxygen (O) relative to a cross-sectional area of a dielectric layer was 0.1% or more and 5% or less, an area percentage of a second secondary phase including nickel (Ni) and oxygen (O) relative to a cross-sectional area of an internal electrode was more than 10%, and an area percentage of a third secondary phase including manganese (Mn), iron (Fe), nickel (Ni), zinc (Zn), and silicon (Si) relative to the cross-sectional area of the dielectric layer was 0.1% or more and 5% or less.

Thermal evaluation (aging rate, ° C./hr) was recorded by applying a frequency of 100 kHz, a temperature of 105° C., and a voltage of 1 kV to 5 sample chips mounted on a PCB using a power supply (keysight E36234A), an oscilloscope (keysight DSOX1204A), and a source meter (keysight 34972A), and measuring a temperature change per hour (° C./hr) using a thermal imaging camera (Flir A400SC).

High-temperature life reliability was recorded by applying conditions of a temperature of 170° C. and a voltage of 1.2 kV to the 5 sample chips mounted on the PCB for 72 hours, among which sample chips were determined to be defective when decreased relative to an initial insulation resistance (IR) value by 10% or less, and converting the number of sample chips determined to be defective into a percentage.

Insulation resistance (IR, Q) was recorded by measuring an insulation resistance (IR) value when a voltage of 500 V was applied for 60 seconds using an insulation resistance (IR) meter (VITREK QTPro II-950) for one sample chip.

COG characteristics was recorded by, in measuring a change in electrostatic capacitance according to a temperature for one sample chip, if ΔC/C_{825° C.}=(0±30 ppm)/° C. was satisfied in a temperature range of −55° C. to 125° C., evaluating as O, and if ΔC/C_{825° C.}=(0±30 ppm)/° C. was not satisfied in a temperature range of −55° C. to 125° C. for one sample chip, evaluating as X.

A quality factor (Q) value was a Q value measured when 100 kHz was applied using an LCR meter measuring device.

TABLE 1

| | | | | High- | | | |
|---|---|---|---|---|---|---|---|
| | 1^{st} | 2^{nd} | Aging | Temperature | Insulation | | |
| | Secondary | Secondary | Rate | Life | Resistance | COG | Q |
| Samples | Phase(%) | Phase(%) | (° C./hr) | Reliability | (IR, Ω) | Characteristics | Values |
| Test | 0.1~10% | 0.5~10% | 0.9 | 0% | More than | ◯ | 5000 or |
| Example 1 | | | | | 10⁹Ω | | more |
| Test | 0.1~5% | 0.1~0.5% | 2.4 | 0% | More than | ◯ | 5000 or |
| Example 2 | | | | | 10⁹Ω | | more |
| Test | 0.1~5% | More | — | 0% | More than | ◯ | Less than |
| Example 3 | | than 10% | | | 10⁹Ω | | 5000 |
| Test | More | 0.5~10% | — | 0% | More than | X | 5000 or |
| Example 4 | than 10% | | | | 10⁹Ω | | more |

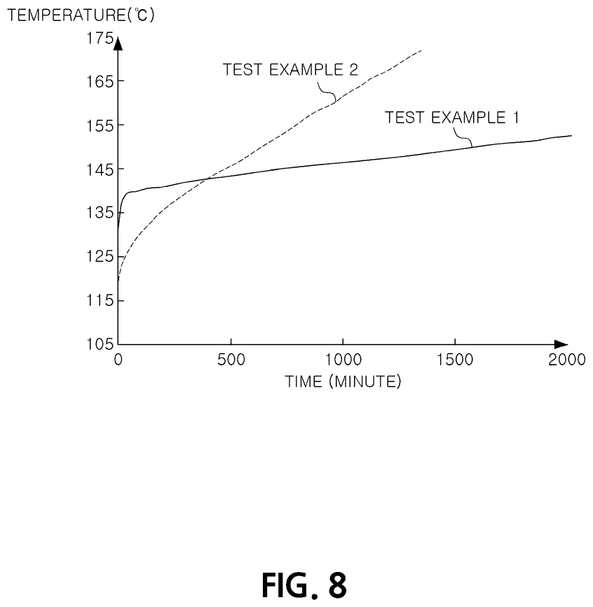

Referring to FIG. 8 depicting results of heat generation evaluation in a graph, it can be seen that, except for an initial period when a heat generation rate rapidly increases, heat generation was relatively suppressed in an aging rate of 0.9° C./hr in Test Example 1, while heat generation was relatively occurred in an aging rate of 2.4° C./hr in Test Example 2. It can be judged that heat generation characteristics were improved because an area percentage of a second secondary phase relative to a cross-sectional area of an internal electrode satisfied 0.5 to 10%. Aging rate evaluation was not performed on Test Examples 3 and 4.

In all of Test Examples 1 to 4, there were no sample chips that failed in high-temperature life reliability evaluation, and since insulation resistance (IR) values all exceeded 10⁹Ω, it can be judged that the high-temperature life reliability and the insulation resistance characteristics were improved when an area percentage of a first secondary phase relative to a cross-sectional area of a dielectric layer satisfied 0.1 to 10% or exceeds 10%. It can be judged that the high-temperature life reliability and the insulation resistance characteristics are improved by including the first secondary phase.

Test Examples 1 to 3 satisfied COG characteristics, while Test Example 4 did not satisfy COG characteristics. It can be judged that temperature characteristics of Test Example 4 became unstable because an area percentage of a first secondary phase relative to a cross-sectional area of a dielectric layer exceeded 10%, and thus it can be seen that it is easy to control to satisfy the COG characteristics when the area percentage of the first secondary phase relative to the cross-sectional area of the dielectric layer satisfies 0.1 to 10%.

Test Examples 1, 2, and 4 measured Q values of 5000 or more, while Test Example 3 measured Q values of less than 5000. It can be judged that the Q value of Test Example 3 decreased because electrical characteristics deteriorated when an area percentage of a second secondary phase relative to a cross-sectional area of an internal electrode exceeded 10%, and thus the Q value decreased. Therefore, it can be seen that the Q value is excellent when the area percentage of the second secondary phase relative to the cross-sectional area of the internal electrode satisfies 0.5 to 10%.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it may be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

One of various effects of the present disclosure is to suppress heat generation of a multilayer electronic component under a high voltage environment.

One of various effects of the present disclosure is to lower equivalent series resistance (ESR) of a multilayer electronic component.

One of various effects of the present disclosure is to improve capacitance characteristics and Q value of a multilayer electronic component.

One of various effects of the present disclosure is that a multilayer electronic component satisfies C0G characteristics.

Various advantages and effects of the present disclosure are not limited to the above-described contents, and can be more easily understood in the process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A multilayer electronic component comprising:
a body comprising a dielectric layer including (Ca, Sr)(Zr, Ti)O₃ as a main component, and an internal electrode alternately disposed with the dielectric layer; and
an external electrode disposed on the body,
wherein the dielectric layer includes a first secondary phase including a rare earth element (RE), zirconium (Zr), and oxygen (O) in an area percentage of 0.1% to 10% relative to a cross-sectional area of the dielectric layer, and
the internal electrode includes a second secondary phase including nickel (Ni) and oxygen (O) in an area percentage of 0.5% to 10% relative to a cross-sectional area of the internal electrode.

2. The multilayer electronic component of claim 1, wherein the main component of the dielectric layer, (Ca, Sr)(Zr, Ti)O₃, satisfies a chemical formula (Ca₁₋ₓ, Srₓ) (Zr_{1-y}, Ti_{y})O₃, wherein 0<x≤0.5, and 0<y≤0.5.

3. The multilayer electronic component of claim 1, wherein the rare earth element (RE) includes at least one selected from the group consisting of yttrium (Y), cerium (Ce), lanthanum (La), praseodymium (Pr), and neodymium (Nd).

4. The multilayer electronic component of claim 1, wherein the dielectric layer includes a third secondary phase including a transition metal and silicon (Si) in an area percentage of 0.1% to 5% relative to a cross-sectional area of the dielectric layer.

5. The multilayer electronic component of claim 4, wherein the transition metal includes at least one selected from the group consisting of manganese (Mn), iron (Fe), nickel (Ni), and zinc (Zn).

6. The multilayer electronic component of claim 1, wherein the first secondary phase includes at least one at least one selected from the group consisting of RE₂Zr₂O₇, REZrO₃, RE₂ZrO₅, and RE-doped ZrO₂,

7. The multilayer electronic component of claim 1, wherein the second secondary phase includes at least one selected from the group consisting of NiO, Ni₂O₃, and Ni₃O₄,

8. The multilayer electronic component of claim 1, having an average length of 2.0 mm or more, and an average width of 1.2 mm or more.

9. The multilayer electronic component of claim 1, wherein an average thickness td of the dielectric layer satisfies td≤10 μm.

10. The multilayer electronic component of claim 1, wherein an average thickness te of the internal electrode satisfies te≤3 μm.

11. The multilayer electronic component of claim 1, wherein an average thickness td of the dielectric layer and an average thickness te of the internal electrode satisfy 2×te<td.

12. A multilayer electronic component comprising:
a body including a dielectric layer including a dielectric material having a perovskite structure (ABO₃) as a main component, and an internal electrode alternately disposed with the dielectric layer; and
an external electrode disposed on the body,
wherein the dielectric layer includes a first secondary phase including a rare earth element (RE) and a B-site element in an area percentage of 0.1% to 10% relative to a cross-sectional area of the dielectric layer, and
the internal electrode includes a second secondary phase including a main component metal of the internal electrode in an area percentage of 0.5% to 10% relative to a cross-sectional area of the internal electrode.

13. The multilayer electronic component of claim 12, wherein the dielectric material having a perovskite structure (ABO₃) includes calcium (Ca) and strontium (Sr), and the B-site element includes zirconium (Zr) and titanium (Ti).

14. The multilayer electronic component of claim 12, wherein the rare earth element (RE) includes at least one selected from the group consisting of yttrium (Y), cerium (Ce), lanthanum (La), praseodymium (Pr), and neodymium (Nd).

15. The multilayer electronic component of claim 12, wherein the main metal of the internal electrode includes at least one selected from the group consisting of nickel (Ni), copper (Cu), palladium (Pd), silver (Ag), gold (Au), platinum (Pt), tin (Sn), tungsten (W), and titanium (Ti).

16. The multilayer electronic component of claim 12, wherein the dielectric layer includes a transition metal including at least one selected from the group consisting of manganese (Mn), iron (Fe), nickel (Ni), and zinc (Zn), and a third secondary phase including silicon (Si), in an area percentage of 0.1% to 5% of a cross-sectional area of the dielectric layer.
